(19) United States
(12) Patent Application Publication
(10) Pub. No.: US 2024/0351896 A1
(43) Pub. Date: Oct. 24, 2024

(54) PROCESS FOR THE PREPARATION OF GREEN AMMONIA SYNTHESIS GAS

(71) Applicant: Topsoe A/S, Kgs. Lyngby (DK)

(72) Inventors: Lari Bjerg Knudsen, Kastrup (DK); Pat A. Han, Smørum (DK)

(73) Assignee: Topsoe A/S, Kgs. Lyngby (DK)

(21) Appl. No.: 18/683,747

(22) PCT Filed: Jul. 20, 2022
(86) PCT No.: PCT/EP2022/070321

§ 371 Date: Feb. 14, 2024

(30) Foreign Application Priority Data
Aug. 19, 2021 (DK) PA202100819

(51) Int. Cl. C01C 1/04; B01D 53/047; B01D 53/86; C01B 21/04

(52) U.S. Cl. CPC C01C 1/0405; B01D 53/047; B01D 53/8671; C01B 21/045; B01D 2256/10; B01D 2257/104; B01D 2258/06

(57) ABSTRACT

Process and system for producing an ammonia synthesis gas, the process comprises the steps of: (a) providing a separate stream comprising nitrogen by pressure swing absorption of ambient air; (b) providing a separate stream comprising hydrogen by electrolysis of water and/or steam; (c) combining the separate streams obtained in steps a) and b) into a mixed stream comprising hydrogen and nitrogen; (d) pressurizing the mixed stream from step (c); and (e) removing residual amounts of oxygen further contained in the mixed stream by catalytic hydrogenation of the oxygen with a part of the hydrogen contained in the mixed stream upstream step (d) and/or downstream step (d) and/or during step (d) to produce the ammonia synthesis gas.

The present invention refers to a process, a system and a plant for producing green ammonia synthesis gas, wherein hydrogen is provided by electrolysis and N₂ is provided by an air separation unit, PSA or membrane separation and wherein oxygen or oxygen containing compounds in a stream of the hydrogen and a stream of the nitrogen are removed in a common deoxidation unit.

Hydrogen from electrolysis and nitrogen from PSA may contain impurities, such as O₂, H₂O, KOH or other, which are usually unwanted in the synthesis of ammonia. These impurities are typically removed by a cleaning unit in order to achieve a close to pure hydrogen and nitrogen ammonia synthesis gas.

If hydrogen is produced at low pressure, i.e. close to atmospheric pressure, approximately 0.1 bar g, it is compressed into the required pressure or the required synthesis pressure, which for NH₃ synthesis is approximately 100-300 bar g. If CO₂ or N₂ are produced at low pressure (e.g., 0.3-1.0 bar g for CO₂) they may be compressed into the required pressure, if necessary.

The standard solution therefore typically comprises a separate cleaning unit for H₂ and for N₂ and also a separate compressor for H₂ and for N₂.

Any oxygen containing compound, in particular oxygen will be a poison to ammonia synthesis catalysts, therefor the specification of the hydrogen and nitrogen purity are normally very strict. In hydrogen production based on electrolysis, a gas clean-up system will typically be required. In nitrogen production, the high purity demand requires that air separation is carried out in cryogenic air separation unit (ASU), which makes the ammonia process costlier and/or less energy efficient.

The present invention provides for the reduction of the number of cleaning units and other equipment such as compressing units in a plant, thereby improving/reducing CAPEX.

The improvement to the standard known solutions described above, is based on employing pressure swing absorption for the separation of atmospheric air (PSA) into nitrogen and oxygen, which operates at near-ambient temperatures and differs significantly from cryogenic air separation, and on combining the streams (H₂+N₂), pressurizing the combined streams preferably in an ammonia synthesis gas compressor and subsequently cleaning the pressurized combined streams in one single unit, in particular a common hydrogenation unit, wherein oxygen is removed by catalytic hydrogenation to water.

Thus, in one aspect the present invention provides a process for producing ammonia synthesis gas comprising the steps of:
(a) providing a separate stream comprising nitrogen by pressure swing absorption of ambient air;
(b) providing a separate stream comprising hydrogen by electrolysis of water and/or steam;
(c) combining the separate streams obtained in steps a) and b) into a mixed stream comprising hydrogen and nitrogen;
(d) pressurizing the mixed stream from step (c); and
(e) removing residual amounts of oxygen further contained in the mixed stream by catalytic hydrogenation of the oxygen with a part of the hydrogen contained in the mixed stream upstream step (d) and/or downstream step (d) and/or during step (d) to produce the ammonia synthesis gas.

When pressurizing the mixed stream prior to the deoxidation step, heat energy is applied to the mixed stream and the temperature of the gas increases. Thereby, a start up heater for the catalytic hydrogenation can be avoided.

Thus, in a preferred embodiment of the invention, the mixed stream of hydrogen and nitrogen is pressurized in an ammonia synthesis gas compressor upstream the catalytic hydrogenation.

The ammonia reaction requires a stoichiometric mole ratio of H₂:N₂ of about 3. Some of the amount of hydrogen is used in the hydrogenation reaction.

Thus, in another preferred embodiment, the mixed stream comprises hydrogen and nitrogen in an amount to provide a molar ratio of H₂ to N₂ of between 2.8 and 3.2.

In another preferred embodiment, the electrolysis is performed in a solid oxide electrolysis cell.

In another preferred embodiment, the catalytic hydrogenation is performed in presence of a hydrogenation catalyst comprising platinum and/or palladium

Another aspect of the invent is a system for producing ammonia synthesis gas comprising:
a) one or more pressure swing absorption units for providing a separate stream comprising nitrogen;
b) one or more electrolysis units for providing a separate stream comprising hydrogen;
c) combining means for providing a mixed stream comprising the separate hydrogen stream and the separate nitrogen stream;
d) a compression unit for pressurizing the mixed stream; and
e) an oxygen hydrogenation unit for the catalytic hydrogenation of oxygen contained in the pressurized mixed stream.

In a preferred embodiment, the compression unit is an ammonia synthesis gas compressor arranged upstream or downstream the hydrogenation unit.

In another preferred embodiment, the electrolysis unit is a solid oxide electrolysis cell.

In another preferred embodiment, hydrogenation unit contains a hydrogenation catalyst comprising platinum and/or palladium.

A third aspect of the invention is a plant comprising a system according to any one of the above embodiments, for operating a process according to any one of the above embodiments.

In summary, the advantages of the invention are:
Low cost of PSA compared to cryogenic ASU for all capacities
PSA is more flexible in operation. Low turn down and fast start-up time compared cryogenic ASU
Dynamic ammonia loop operates on varying power input from solar and wind between 5 to 100% load. Therefore, is the flexible PSA an advantage in dynamic ammonia loops operated on renewal energy.
Combined hydrogenation unit for the removal of oxygen in both hydrogen and nitrogen feed streams instead of individual unit for each feed stream.
When the hydrogenation unit is arranged upstream at the discharge of synthesis gas compressor the need for start up heater will be eliminated.
Higher pressure will favor reaction and reduce catalyst volume in the hydrogenation unit.
Higher temperature will favor hydrogenation of oxygen.

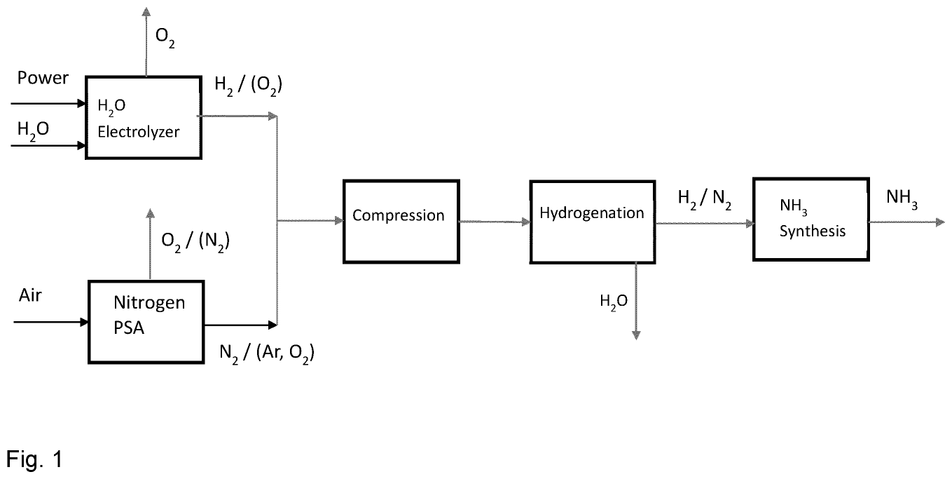

FIG. 1 in the drawings shows a preferred embodiment of the present invention for generation of H₂ and N₂ streams for synthesizing green ammonia,

where compression step is performed, upstream to a joint oxygen removal from a combined stream of or H₂ and N₂.

The hydrogen stream from the electrolyzer typically contains 99.9 mole % H₂ and 0.1 mole % O₂. The nitrogen stream from the PSA unit typically contains 99.2 mole % N₂, 0.3 mole % O₂ and 0.5 mole % Ar as impurities.

As mentioned hereinbefore, oxygen in ammonia synthesis gas will poison the ammonia catalyst and is therefore necessary to remove the oxygen contained in the hydrogen stream and in the nitrogen stream by catalytic hydrogenation of the oxygen to water.

By the present invention the streams are combined in a molar ratio of H₂ to N₂ of about 2.8 to 3.2 and compressed in an upstream synthesis gas compressor and subsequently cleaned in hydrogenation unit.

In the hydrogenation unit, oxygen will be removed by a catalyzed reaction with hydrogen to form water. Most of the water will be knocked out in an interstage cooling and separation before the thus prepared ammonia synthesis gas is introduced into a downstream ammonia loop.

1. Process for producing an ammonia synthesis gas comprising the steps of:
(a) providing a separate stream comprising nitrogen by pressure swing absorption of ambient air;
(b) providing a separate stream comprising hydrogen by electrolysis of water and/or steam;
(c) combining the separate streams obtained in steps a) and b) into a mixed stream comprising hydrogen and nitrogen;
(d) pressurizing the mixed stream from step (c); and
(e) removing residual amounts of oxygen further contained in the mixed stream by catalytic hydrogenation of the oxygen with a part of the hydrogen contained in the mixed stream upstream step (d) and/or downstream step (d) and/or during step (d) to produce the ammonia synthesis gas.

2. Process according to claim 1, wherein the mixed stream comprising hydrogen and nitrogen is pressurized in an ammonia synthesis gas compressor upstream the catalytic hydrogenation.

3. Process according to claim 1, wherein the mixed stream comprises hydrogen and nitrogen in an amount to provide a molar ratio of H₂ to N₂ of between 2.8 and 3.2.

4. Process according to claim 1, wherein the electrolysis is performed in a solid oxide electrolysis cell.

5. Process according to claim 1, wherein the catalytic hydrogenation is performed in presence of hydrogenation catalyst.

6. System for producing ammonia synthesis gas comprising:
a) one or more pressure swing absorption units for providing a separate stream comprising nitrogen;
b) one or more electrolysis units for providing a separate stream comprising hydrogen;
c) combining means for providing a mixed stream comprising the separate hydrogen stream and the separate nitrogen stream;
d) a compression unit for pressurizing the mixed stream; and
e) an oxygen hydrogenation unit for the catalytic hydrogenation of oxygen contained in the pressurized mixed stream.

7. System according to claim 6, wherein the compression unit is an ammonia synthesis gas compressor arranged upstream or downstream the hydrogenation unit.

8. System according to claim 6, wherein the electrolysis unit is a solid oxide electrolysis cell.

9. System according to claim 6, wherein the hydrogenation unit contains a hydrogenation catalyst.

10. Plant comprising a system according to claim 6, for operating a process for producing an ammonia synthesis gas, comprising the steps of:
(a) providing a separate stream comprising nitrogen by pressure swing absorption of ambient air;
(b) providing a separate stream comprising hydrogen by electrolysis of water and/or steam;
(c) combining the separate streams obtained in steps a) and b) into a mixed stream comprising hydrogen and nitrogen;
(d) pressurizing the mixed stream from step (c); and
(e) removing residual amounts of oxygen further contained in the mixed stream by catalytic hydrogenation of the oxygen with a part of the hydrogen contained in the mixed stream upstream step (d) and/or downstream step (d) and/or during step (d) to produce the ammonia synthesis gas.
